(19) United States
(12) Patent Application Publication
(10) Pub. No.: US 2021/0099127 A1
(43) Pub. Date: Apr. 1, 2021

(54) Energy Harvesting System for Active Cooling of Automotive Sensing Devices

(71) Applicant: Lyft, Inc., San Francisco, CA (US)

(72) Inventors: Srinivasa Rao Damaraju, Fremont, CA (US); Alexander Charles Granieri, Palo Alto, CA (US); Alfred Charles Jones, II, Belmont, CA (US); Steven Son Khau, Belmont, CA (US); Marco Antonio Marroquín, San Mateo, CA (US)

(21) Appl. No.: 16/589,110

(22) Filed: Sep. 30, 2019

(51) Int. Cl. H02S 40/42; B60L 1/00; H02S 40/44; B60L 8/00

(52) U.S. Cl. CPC H02S 40/425; B60L 8/003; H02S 40/44; B60L 1/20

(57) ABSTRACT

In one embodiment, the apparatus includes a system for harvesting energy and cooling an automotive sensing unit, the system comprising a solar-energy collecting panel, a turbine, and an electrical energy storage device. The solar-energy collecting panel shields the sensor device from solar irradiation while converting solar energy to electrical energy for storage in the storage device. The turbine converts convective heat flow from the sensor device into electrical energy for storage in the storage device. The stored electrical energy in the storage device can be further used to power an active cooling system for the sensor device. The stored electrical energy can also be further used to power other systems of the host vehicle.

### BACKGROUND

Sensing devices and sensor pods are an integral part of autonomous and semiautonomous vehicle systems. In a sensor pod, LiDAR, video imaging, RADAR, and other sensors types are often arrayed, co-located, and integrated into a single, compact unit to minimize volume and weight. By using many sensors with each sensor assigned to a section of a field of view, sensors pods can provide comprehensive data on the local driving environment to on-board electronic computing units (ECUs). Based on the sensor data, ECUs can then perform the functions necessary for autonomous or semiautonomous operation of the vehicle.

### BRIEF DESCRIPTION OF THE DRAWINGS

FIG. 1 illustrates an example automotive environment for an automotive sensor pod.

FIG. 2 illustrates a cross section of a system for energy harvesting and active cooling of an automotive sensor pod.

FIG. 3 illustrates a cross section of the energy harvesting system operating while the host vehicle is in a stationary state.

FIGS. 4A-4B illustrate a cross section of the energy harvesting system operating while the host vehicle is in motion.

FIG. 5 illustrates the possible routing modes of stored electrical energy by the energy harvesting and active cooling system.

FIG. 6 illustrates an example embodiment of the energy harvesting system providing active cooling while the host vehicle is stationary.

FIGS. 7A-7B illustrate an energy harvesting system for active cooling of an automotive sensing device in a temperature-controlled case.

FIG. 8 illustrates an example of a computing system.

### DESCRIPTION OF EXAMPLE EMBODIMENTS

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. In addition, the embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Automotive sensing devices can include LiDAR, radar, video cameras, and other sensor types. Automotive sensor pods are comprised of an array of sensing devices which are co-integrated and contained within a single unit. The combined heat dissipation of the sensors, and their associated circuitry, result in a large amount of heat being generated by the sensor pod. Active cooling solutions for sensor pods are therefore desirable. A system for powering an active cooling solution and harvesting energy from the environment, while also providing additional passive cooling to the sensor pod, presents benefits in terms of cooling system efficiency and overall vehicle efficiency. Furthermore, excess energy produced by such a system can be used to power other vehicle subsystems, such as electronic computing units (ECUs).

Sensors are a critical component of autonomous and semi-autonomous vehicle systems. Sensors are often grouped together and co-integrated within a single unit called a sensor pod. This configuration is preferred when sensors are tasked with collecting panoramic or immersive data from a wide field-of-view. A sensor pod may be placed at a location on the vehicle that allows a panoramic or wide-angle view, such as the vehicle's roof. An example application of a sensor pod would be an encased array of video cameras or LiDAR sensors to collect data for simultaneous localization and mapping (SLAM) for an autonomous or semi-autonomous vehicle. Another example of a sensor pod would an encased array of radar transceivers. Applications of a radar sensor pod for autonomous or semi-autonomous vehicles include blind spot detection, collision avoidance, proximity sensing, or lane-change assist.

Sensors such as video cameras, LiDAR, or radar transceivers are comprised of integrated circuits (ICs). The sensing elements of video cameras and LiDAR devices include charge coupled devices (CCDs), which are further coupled to signal processing chipsets and micro-controller units (MCUs). The electrical power consumed by these components is converted into heat via resistive power dissipation (i.e. Joule heating). The combined heat generation of a sensor array within a sensor pod can result in temperatures approaching 100° C., which can reduce reliability of most ICs, resulting in logical faults and errors.

The heat generated by the sensor arrays often necessitates the use of passive or active thermal management. Passive thermal management techniques include the blocking of impinging radiation (e.g. shading), the use of a heatsink, or the use of cooling vents to allow convective heat flow from within the sensor pod. Active thermal management techniques include the use of a cooling loop to transfer the heat of the sensor array to a circulating coolant fluid. For example, a cooling loop may comprise a pump, a loop channel, a cooling plate coupled to the sensor array, and a radiator. Through the action of the pump, coolant circulates and carries heat away from the cooling plate to the radiator, thereby cooling the sensor array. Another example of active convective cooling would be the use of a cooling fan directed at the sensor array to impel a cooling air flow over the sensor array. Further examples of active cooling include thermoelectric coolers (TECs) relying on the Peltier effect.

An active thermal management system for a sensor pod requires a supply of electrical energy to power the active or power-consuming components of the thermal management system. Examples of power-consuming components include the pump within a cooling loop, or a cooling fan. Possible supplies for the required electrical energy may be the vehicle's own auxiliary power outlet, battery, or alternator. Alternatively, electrical power can be supplied by one or more power sources or energy supplies separate from the vehicle's own electrical power supply. An example would be the use of energy harvesters to supply the needed electrical energy. Examples of energy harvesters include solar-energy collecting panels, such as photovoltaic panels, to convert solar radiation to electrical energy, or turbines to convert the momentum from air moving within or around the vehicle into electrical energy. Further examples include harvesting mechanical energy through piezoelectric transducers or resonant structures. Harvesting the potential energy of temperature gradients through thermoelectric generators (TEGs) is another example.

The use of energy harvesting techniques to provide electrical power for an active cooling system for an automotive sensor pod or sensing device improves the overall vehicle energy efficiency. This improved energy efficiency can be evaluated relative to the use of the vehicle's own on-board electrical power supply. For example, instead of using the vehicle's on-board power supply, the active sensor cooling system could instead be partially or wholly self-powered, at no cost to the host vehicle in terms of stored electrical energy or fuel that must be converted into electrical energy. This latter advantage translates to increased fuel economy.

Excess electrical energy supplied by the energy harvesting system could be used to power one or more of the host vehicle's subsystems. For example, any electrical energy not consumed by the active cooling system for the sensor unit could instead be used to power one or more of the host vehicle's electronic compute units (ECUs). In this manner, the use of an energy harvesting system can further increase fuel economy and overall vehicle efficiency by reducing the amount of host vehicle energy needed to power the ECUs by using the supplemental power from the energy harvesting system.

Excess electrical energy supplied by the energy harvesting system could be used to power the one or more sensor pods or sensor units of the host vehicle. For example, any electrical energy not consumed by the active cooling system for the sensor unit could instead be used to power the sensor unit itself In this manner the sensor unit coupled to the energy harvesting system could be become completely energy self-sufficient.

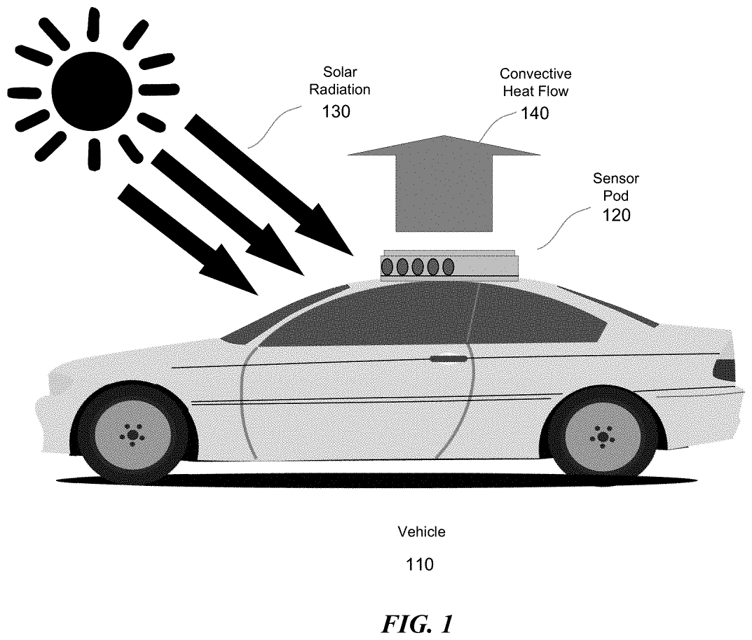

FIG. 1 illustrates an example autonomous or semi-autonomous vehicle 110. Attached to the roof of the vehicle is a sensor pod 120. The sensor pod is comprised of an enclosure with one or more viewports. Behind each viewport may be one or more sensors comprising a sensor array. As an example, the sensor pod 120 may house one or more LiDAR sensors for a SLAM application. The viewports and associated LiDAR sensors are positioned to provide a panoramic view from the top of the vehicle, as is typical of the SLAM application.

The vehicle and its associated sensor pod may be operating in a sunny environment, affording a large amount of solar irradiation 130 onto the vehicle surface. The impinging solar radiation may increase the heat load on the sensor pod, further increasing its temperature. For example, in California solar radiation intensity may be as high as 1000 W/m² on a sunny day. The magnitude of solar radiation intensity may allow for sun-facing surfaces of the vehicle to be fitted with photovoltaic panels. The sensor pod, being positioned on the roof of the vehicle, may have sufficient surface area to harvest useful amounts of energy from the impinging solar radiation. For example, a silicon photovoltaic panel may have a conversion efficiency of 20%. For a 1 m² photovoltaic panel fitted above the sensor pod, 200 W of electrical power may be supplied by the panel on a sunny day.

The sensor pod may generate a large amount of heat during its operation. The heat generated by the sensor pod is largely transferred to the surrounding air. The convective heat flow 140 subsequently generated can take two forms depending on the velocity of the host vehicle. When the vehicle is stationary, the heat flow will travel upward and dissipate into the free space of the atmosphere. When the vehicle is in motion, the heat flow will conform to the streamlines of the air flow surrounding the vehicle and be carried behind the vehicle. In the former case, the free space above the sensor pod provides a large reservoir into which heat from the sensor pod can be transferred. Consequently, placing closed spaces or other obstructions to the heat plume above the sensor pod would act to impede this mode of heat transfer when the vehicle is stationary. For this reason, placing objects, such as photovoltaic panels, above the sensor pod is generally undesirable. Therefore, the heat-trapping caused by such obstructions may require supplemental active cooling for the sensor pod.

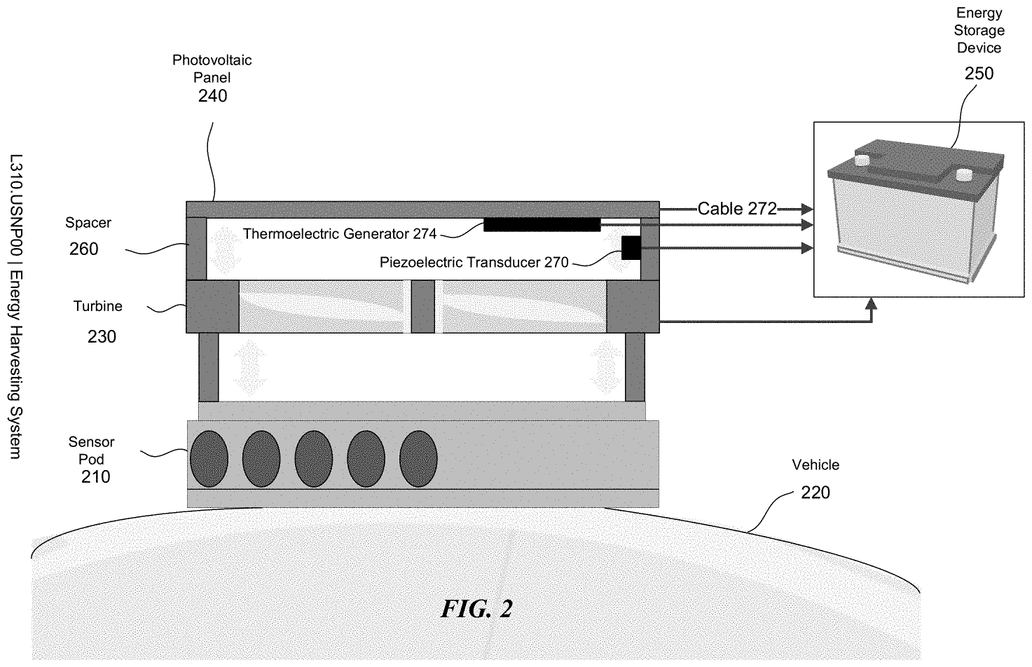

FIG. 2 illustrates a particular embodiment of an energy harvesting system for active cooling of an automotive sensor device. The exploded cross section of the particular embodiment shows the sensor pod 210 affixed to the roof of the vehicle 220. Atop the sensor pod 210 are the two energy harvesting components of the system: a turbine 230 and a photovoltaic panel 240. The photovoltaic panel 240 is positioned above the turbine, which is in turn positioned above the sensor pod 210. The photovoltaic panel and turbine are coupled by cables 272 to an energy storage device 250 (e.g. a battery) for storage of the harvested energy.

In particular embodiments, the vertical distance between the sensor pod and turbine, or turbine and photovoltaic panel, may be determined by spacers 260 located at the perimeter of the system. The spacers may have vents, inlets, or outlets allowing air flow into or out of the system. The spacers may be of a range of vertical dimensions.

In particular embodiments, the energy harvesting components of the system may further include other energy harvesting devices coupled to the energy storage device, e.g., by electrical cables 272 or other conducting mechanism. These further devices may include piezoelectric transducers 272 or other mechanically resonant structures to harvest energy from mechanical vibrations such as the vibration and movement of the vehicle as it drives on a road surface. These further devices may also include one or more thermoelectric generators 274 to harvest energy from temperature gradients, such as the difference in temperature between the photovoltaic panel 240 and a cooler region or area, such as the air between the photovoltaic panel 240 and the turbine 230 or the sensor pod 210, or the difference in temperature between the photovoltaic panel 240 and a surface of the sensor pod 210 or of a sensor pod cooling unit.

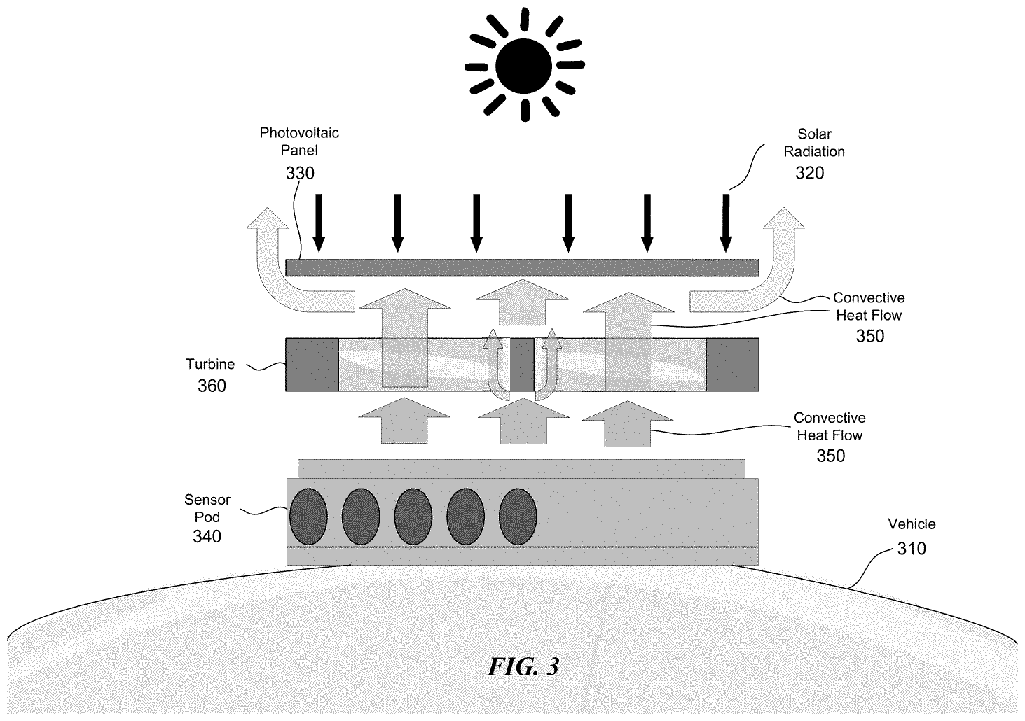

FIG. 3 illustrates an example of the energy harvesting system operating while the host vehicle 310 is stationary. The impinging solar radiation 320 is absorbed by the photovoltaic panel 330, thereby generating electrical energy (e.g., via charge carrier excitation) for storage. The photovoltaic panel 330 also shields the sensor pod 340 from the solar radiation 320, thereby preventing heating of the sensor pod by direct solar irradiation. The heat internally generated by the sensor pod due to its normal operation produces a convective heat flow 350 from the sensor pod 340. The upward-moving convective heat flow 350 drives the turbine 360. In the process of driving the turbine, the fan blades of the turbine are impelled by the convective heat flow 350, causing an electric generator coupled to the turbine shaft to produce electric current (via Faraday's law) for storage. The convective heat flow 350 is then allowed to escape into the open atmosphere via outlets located above the turbine.

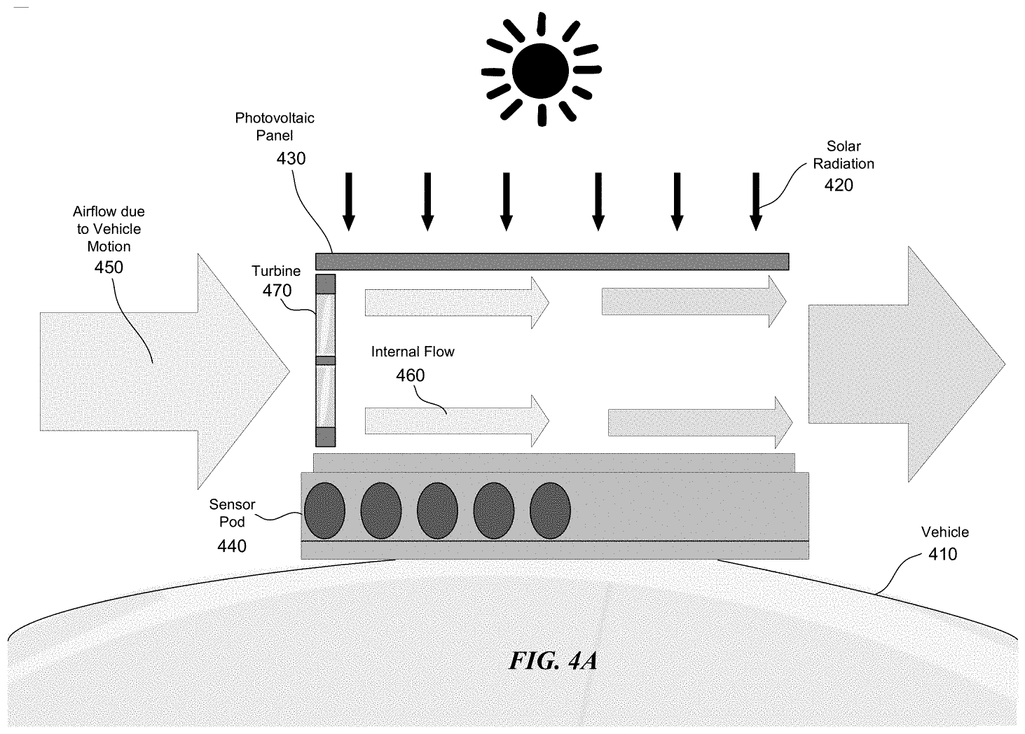

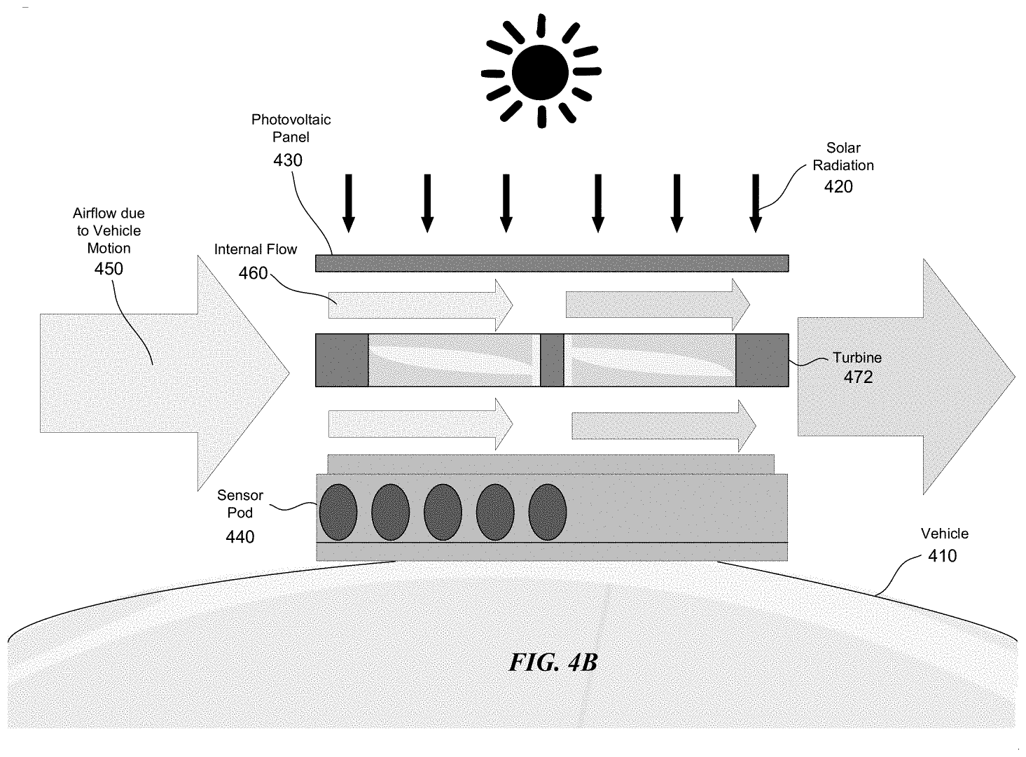

FIG. 4A illustrates an example of the energy harvesting system operating while the host vehicle 410 is in motion. The impinging solar radiation 420 is again absorbed by the photovoltaic panel 430, thereby generating electrical energy for storage. The photovoltaic panel also again shields the sensor pod 440 from the solar radiation, thereby preventing any heating of the sensor pod by direct solar irradiation. Due to the motion of the host vehicle, an oncoming air flow 450 exists at the boundary of the system. Internal flow 460 within the system is produced from the oncoming flow 450 due to inlet vents in the spacer walls between the sensor pod 440, turbine 470, and photovoltaic panel 430. The turbine 470 may be impelled by the internal flow 460 to produce electrical energy for storage. The internal flow 460 convectively transfers heat from the sensor pod 440 to the external atmosphere via one or more outlet vents located toward the rear boundary of the system.

In particular embodiments, a second turbine, oriented in the direction of the internal flow 460, may be included in the system. During vehicle motion, the second turbine may be impelled by the internal flow to produce electrical energy for storage. In this manner, the energy generated by the second turbine may compensate for the electrical energy not generated by the first turbine during vehicle motion. FIG. 4B illustrates an example of the energy harvesting system operating while the host vehicle 410 is in motion. FIG. 4B is similar to FIG. 4A, but shows a turbine 472 oriented in the direction of the convective heat flow from the sensor pod (at least while the vehicle is stationary) instead of the turbine 470. Due to the motion of the host vehicle, an oncoming air flow 450 exists at the boundary of the system. Internal flow 460 within the system is produced from the oncoming flow 450 due to inlet vents in the spacer walls between the sensor pod 440, turbine 472, and photovoltaic panel 430. The internal flow 460 convectively transfers heat from the sensor pod 440 to the external atmosphere via one or more outlet vents located toward the rear boundary of the system. Since the internal flow created by the vehicle motion inhibits or precludes convective heat flow through the turbine 472 from the sensor pod 440, the turbine 472 may be disengaged during vehicle motion. The turbine 472 may be engaged or re-engaged when the vehicle is stationary, so that the fan blades of the turbine 472 are impelled by the convective heat flow 350, which may cause an electric generator coupled to a shaft of the turbine 472 to produce electric current for storage.

In particular embodiments, both a first turbine 470 oriented in the direction of the internal flow 460 and a second turbine 472 oriented in the direction of the convective heat flow from the sensor pod (at least while the vehicle is stationary), may be included in the system. When the vehicle is stationary, the second turbine 472 may be engaged or re-engaged and impelled by convective head flow 350 to produce electrical energy for storage. The first turbine 470 may be disengaged while the vehicle is stationary. The energy generated by the second turbine 472 may compensate for the electrical energy no generated by the first turbine 470 while the vehicle is stationary. During vehicle motion, the first turbine 470 may be engaged and impelled by the internal flow 460 to produce electrical energy for storage. The second turbine 472 may be disengaged during vehicle motion. The energy generated by the first turbine 470 may compensate for the electrical energy not generated by the second turbine 472 during vehicle motion. Alternatively or additionally, the energy harvesting system may include a movable turbine that can move between being oriented in the direction of the internal flow 460 (e.g., as the turbine 470 is oriented) and being oriented in the direction of the convective heat flow from the sensor pod (e.g., as the turbine 472 is oriented). The movable turbine may rotate along an axis, slide along a track, or otherwise move between the two orientations. The movable turbine may thus be oriented at any suitable angle to between a horizontal orientation and a vertical orientation. Further, although the orientations of the turbines 470, 472 are shown as vertical and horizontal, respectively, either or both of the turbines 470, 472 may be oriented at other angles in which at least a portion of the internal flow 460 or convective flow may pass through and impel the turbine.

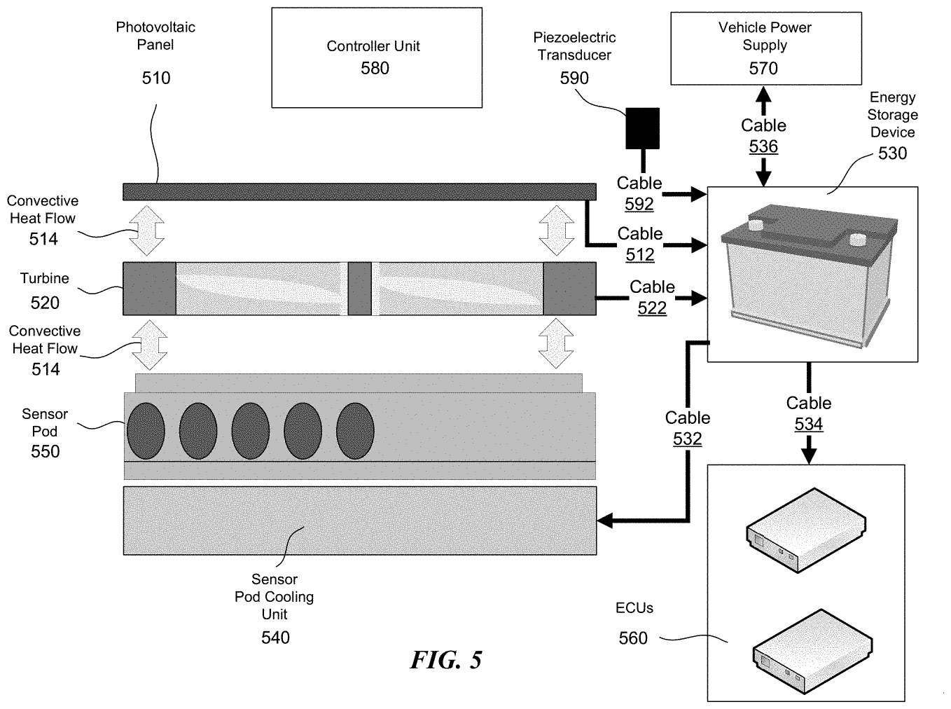

FIG. 5 illustrates an example schematic of the energy harvesting system for active cooling of an automotive sensor pod 550. The system comprises a photovoltaic panel 510, a turbine 520, and a piezoelectric transducer 590 coupled an energy storage device 530. The photovoltaic panel 510 may be coupled to, and provide electrical energy to, the energy storage device 530 via a cable 512. The cable 512 and other cables described herein may be, e.g., a conducting wire enclosed in suitable insulation. Similarly, the turbine 520 may be coupled to, and provide electrical energy to, the energy storage device 530 via a cable 522. Upward-moving and/or downward moving convective heat flow 514 may drive the turbine 520. In the process of driving the turbine, the fan blades of the turbine are impelled by the convective heat flow 514, causing an electric generator coupled to the turbine shaft to produce electric current for storage in the energy storage device 530. The convective heat flow 514 may then be allowed to escape into the open atmosphere via outlets located above the turbine or elsewhere in the energy harvesting system. The piezoelectric transducer is coupled to, and may provide energy to, the energy storage device 530 via a cable 592. The system may further comprise other energy harvesting devices (e.g. piezoelectric transducers, TEGs, etc.) coupled to the energy storage device. The energy storage device can be a chemical battery, capacitor, or other system for storing electrical energy.

The energy storage device 530 provides electrical power via a cable 532 to the sensor pod cooling unit 540 for active cooling of the sensor pod 550. The sensor pod cooling unit may comprise one or more active cooling systems. Such cooling systems may include one or more fans, cooling loops driven by a pump, thermoelectric coolers (TECs), fan sinks (fans coupled to heat sinks) or any other cooling mechanism requiring electric power.

In particular embodiments, the energy storage device 530 may accumulate electrical energy faster than the electrical energy is being consumed by the sensor pod cooling unit 540. In such cases, the system may be configured to provide any excess electrical energy stored in the energy storage device 530 to one or more subsystems of the host vehicle. An example of such a subsystem would be the electronic control units (ECUs) 560 of the host vehicle, to which the energy storage device 530 may provide electrical power via a cable 534. In this manner, the energy consumption of the ECUs could be supplemented by the excess energy of the energy harvesting system, e.g., by routing electrical power from the energy storage device 530 to the one or more subsystems. For example, if the energy storage device 530 were accumulating power at a rate of 5 W, and the sensor pod cooling unit 540 were consuming power at a rate of 4 W, then the excess 1 W of power may be provided to the energy storage device 530 by routing electrical power from the energy storage device to the one or more subsystems while the excess power is greater than zero. Alternatively, the excess energy could be supplied to the host vehicle's power supply 570 or to the sensor pod 550.

In particular embodiments, the energy storage device may not accumulate electrical energy as fast as the electrical energy is being consumed by the sensor pod cooling unit 540. In such cases, the system, e.g., at least the sensor pod cooling unit 540, may be coupled to the host vehicle's power supply 570 to provide a continuous and stable supply of electrical power to the sensor pod cooling unit 540 by supplementing the system's own power supply with that of the host vehicle. For example, the energy storage device 530 may be coupled to the host vehicle's power supply 570 via a cable 536. As a further example, if the sensor pod cooling unit were consuming power at a rate of 2 W, and the storage device had only 10 J of energy stored with no power input from the energy harvesting devices, the energy storage device would have 5 s of supply remaining before depletion. The system could determine and execute, by use of one or more dedicated compute units, a transition to the host vehicle's power supply after 5 s to maintain continuous power to the sensor pod cooling unit.

To determine and actuate the various modes of energy harvesting, energy storage, energy transfer, and thermal management of the sensor pod, a controller unit 580 may be employed. The controller unit may comprise a computing unit or digital logic device coupled to one or more sensors, relays, switches, or power converters. For example, the controller unit may actuate the sensor pod cooling unit 540 upon determining that the operating temperature range of the sensor has been exceeded. This determination may be based upon data from a temperature sensor connected to the controller. As another example, the controller may open a relay or switch to allow current to flow to the sensor pod cooling unit from the vehicle power supply 570. The controller may alternatively switch to the energy storage device 530 for powering the sensor pod cooling unit. The controller may furthermore open a relay to allow electric current to flow to the one or more ECUs 560 of the host vehicle. The controller may execute software to allow for a plurality of control behaviors to be implemented.

The sensor unit may be modular and independent of external power sources such as the vehicle power supply 570. Thus, although the vehicle power supply 570 is describe as providing electrical power to the energy storage device 530, the modular sensor unit may generate power for the sensor pod 550 and/or sensor pod cooling unit 540 using the photovoltaic panel 510 and/or turbine 520 without using power from the vehicle power supply 570. For example, the sensor unit may include a system energy storage device such as a battery (not shown) that receives power from the photovoltaic panel 510 and the turbine 520 via cables similar to cables 512, 522, and a sensor pod cooling unit 540 that receives power from the system energy storage device via a cable similar to the cable 532. Alternatively, the sensor unit may use the energy storage device 530 as described above and shown in FIG. 5, but may, over a defined period of time, provide at least as much electrical energy to the energy storage device 530 than it consumes. As another example, the sensor unit may include a system energy storage device that provides power to the sensor pod cooling unit 540 and receives power from the photovoltaic panel 510 and/or turbine 520, but the sensor pod cooling unit 540 may consume power from the vehicle's energy storage device 530 if the sensor pod 550 is or is projected to be above its operating temperature limit and no power is available from the system energy storage device.

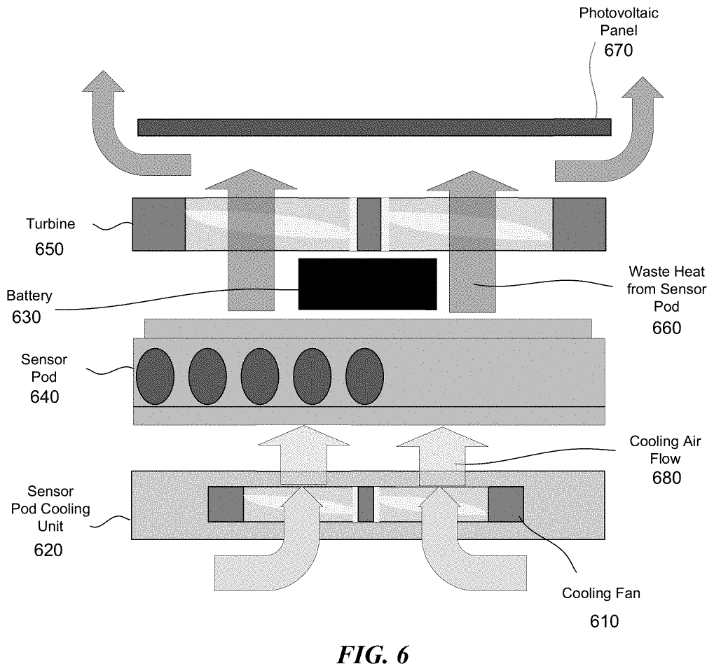

FIG. 6 illustrates an example embodiment of the energy harvesting system for active cooling of an automotive sensor pod, showing a fan 610 as the active cooling element comprising the sensor pod cooling unit 620. In this embodiment, the system battery 630 is located between the automotive sensor pod 640 and the harvesting turbine 650. The battery may be an example of the system energy storage device described above with reference to FIG. 5.

When a host vehicle is in its stationary state, the waste heat from the sensor pod creates a rising plume of air 660. This plume impels the turbine 650, which generates electric power. In sunny conditions, the photovoltaic panel 670 will also generate electric power. The combined power generated by the photovoltaic panel 670 and turbine may be stored in the battery 630. The stored power can subsequently be used to power the cooling fan 610 in the sensor pod cooling unit 620. The cooling fan 610 subsequently creates a cooling air flow 680 which can be passed through the sensor pod 640 to maintain it within its operating temperature range. The temperature of the heat plume may decrease, reducing the harvesting efficiency of the turbine. The controller for the system may subsequently act to shut off the cooling fan if the sensor pod is within its operating temperature range. Alternatively, the controller may source more power from the vehicle power supply or battery if more cooling power is needed. Since the system includes a battery, and may provide energy to the battery from the photovoltaic panel 670 and/or the turbine 650, the system may be independent of the vehicle's power system, including the vehicle power supply 570 and the energy storage device 530. Since it is independent of external power sources, the system may be used to create a sensor unit that improves installation and fuel/power efficiency of the vehicle. For example, if the sensor unit does not use the vehicle's power system, then installation may be simplified and more efficient because there is no need to connect a cable from the energy harvesting system to the vehicle's power system. Maintenance time and effort may also be reduced, and reliability increased, because there is no need to maintain or repair a cable connecting the energy harvesting system to the vehicle's power system. As another example, fuel and/or power efficiency of the vehicle may be increased, e.g., as compared to a sensor pod that does not use the energy harvesting system, because the energy harvesting system can generate energy for the sensor pod cooling unit 540 (and/or the sensor pod 550) independently of the vehicle power system without using any energy from the vehicle's power system.

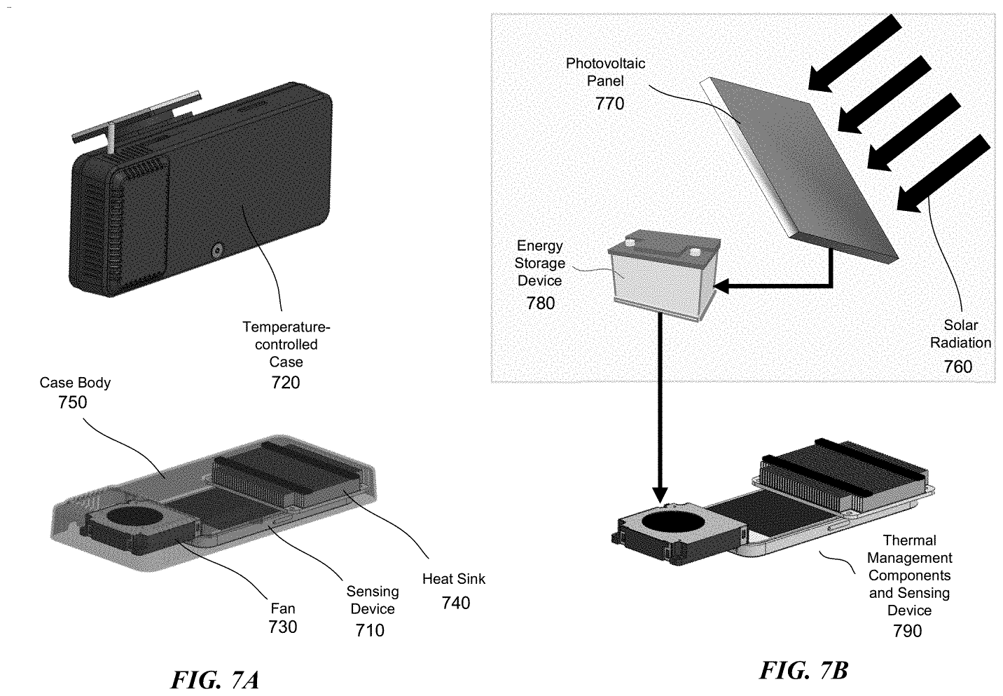

FIG. 7A illustrates an example of a temperature-controlled case 720 for an automotive sensing device with active thermal management components. A sensing device 710 may be a smartphone, camera, tablet, mobile computing device, or any system comprising sensors for automotive applications. The sensing device may not necessarily be in an area of the host vehicle where air flow due to vehicle motion can be used as a cooling mechanism for the sensing device.

The sensing device may be enclosed in a temperature-controlled case 720 with one or more active thermal management components requiring electric power. Such components may include a fan 730, cooling loop, TEC, or other active thermal management components. The case may additionally contain passive thermal management components such as a heat sink 740. The thermal management components and sensing device may additionally be contained in a case body 750.

FIG. 7B illustrates an example of an energy harvesting system for active cooling of an automotive sensing device 710. The temperature-controlled case 720 enclosing the sensing device 710 may be in an area of the vehicle (e.g. attached to a windshield) where it is exposed to solar radiation 760. The associated energy harvesting system may comprise a photovoltaic panel 770 coupled to an energy storage device 780. The photovoltaic panel may be affixed to the temperature-controlled case 720 or otherwise located in an area of the vehicle where there is a substantial amount of solar irradiation. The energy storage device may be coupled to the active components and/or sensing device 790 of the temperature-controlled case 720 to supply electrical energy to the active thermal management components (e.g., the fan). In this manner, the energy harvesting system powers the active cooling of sensing devices that cannot exploit the cooling effect of air flow caused by the motion of the host vehicle.

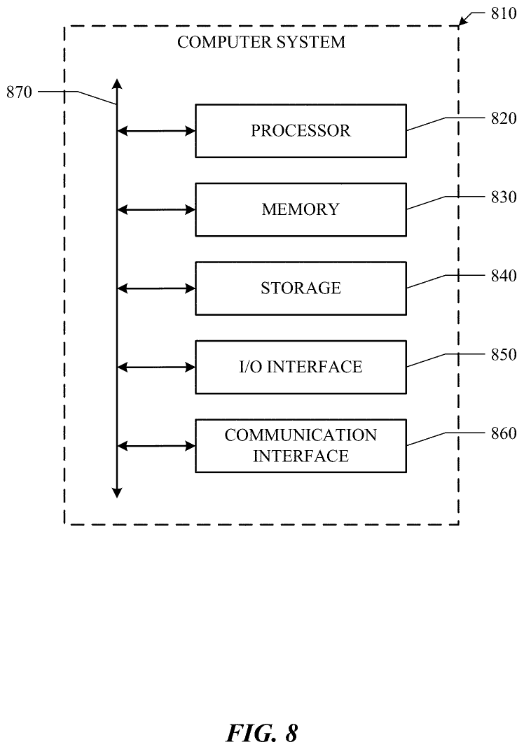

FIG. 8 illustrates an example computer system 810. In particular embodiments, one or more computer systems 810 perform one or more steps of one or more methods described or illustrated herein. In particular embodiments, one or more computer systems 810 provide the functionalities described or illustrated herein. In particular embodiments, software running on one or more computer systems 810 performs one or more steps of one or more methods described or illustrated herein or provides the functionalities described or illustrated herein. Particular embodiments include one or more portions of one or more computer systems 810. Herein, a reference to a computer system may encompass a computing device, and vice versa, where appropriate. Moreover, a reference to a computer system may encompass one or more computer systems, where appropriate.

This disclosure contemplates any suitable number of computer systems 810. This disclosure contemplates computer system 810 taking any suitable physical form. As example and not by way of limitation, computer system 810 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 810 may include one or more computer systems 810; be unitary or distributed; span multiple locations; span multiple machines; span multiple data centers; or reside in a cloud, which may include one or more cloud components in one or more networks. Where appropriate, one or more computer systems 810 may perform without substantial spatial or temporal limitation one or more steps of one or more methods described or illustrated herein. As an example and not by way of limitation, one or more computer systems 810 may perform in real time or in batch mode one or more steps of one or more methods described or illustrated herein. One or more computer systems 810 may perform at different times or at different locations one or more steps of one or more methods described or illustrated herein, where appropriate.

In particular embodiments, computer system 810 includes a processor 820, memory 830, storage 840, an input/output (I/O) interface 850, a communication interface 860, and a bus 870. Although this disclosure describes and illustrates a particular computer system having a particular number of particular components in a particular arrangement, this disclosure contemplates any suitable computer system having any suitable number of any suitable components in any suitable arrangement.

In particular embodiments, processor 820 includes hardware for executing instructions, such as those making up a computer program. As an example and not by way of limitation, to execute instructions, processor 820 may retrieve (or fetch) the instructions from an internal register, an internal cache, memory 830, or storage 840; decode and execute them; and then write one or more results to an internal register, an internal cache, memory 830, or storage 840. In particular embodiments, processor 820 may include one or more internal caches for data, instructions, or addresses. This disclosure contemplates processor 820 including any suitable number of any suitable internal caches, where appropriate. As an example and not by way of limitation, processor 820 may include one or more instruction caches, one or more data caches, and one or more translation lookaside buffers (TLBs). Instructions in the instruction caches may be copies of instructions in memory 830 or storage 840, and the instruction caches may speed up retrieval of those instructions by processor 820. Data in the data caches may be copies of data in memory 830 or storage 840 that are to be operated on by computer instructions; the results of previous instructions executed by processor 820 that are accessible to subsequent instructions or for writing to memory 830 or storage 840; or any other suitable data. The data caches may speed up read or write operations by processor 820. The TLBs may speed up virtual-address translation for processor 820. In particular embodiments, processor 820 may include one or more internal registers for data, instructions, or addresses. This disclosure contemplates processor 820 including any suitable number of any suitable internal registers, where appropriate. Where appropriate, processor 820 may include one or more arithmetic logic units (ALUs), be a multi-core processor, or include one or more processors 820. Although this disclosure describes and illustrates a particular processor, this disclosure contemplates any suitable processor.

In particular embodiments, memory 830 includes main memory for storing instructions for processor 820 to execute or data for processor 820 to operate on. As an example and not by way of limitation, computer system 810 may load instructions from storage 840 or another source (such as another computer system 810) to memory 830. Processor 820 may then load the instructions from memory 830 to an internal register or internal cache. To execute the instructions, processor 820 may retrieve the instructions from the internal register or internal cache and decode them. During or after execution of the instructions, processor 820 may write one or more results (which may be intermediate or final results) to the internal register or internal cache. Processor 720 may then write one or more of those results to memory 830. In particular embodiments, processor 820 executes only instructions in one or more internal registers or internal caches or in memory 830 (as opposed to storage 840 or elsewhere) and operates only on data in one or more internal registers or internal caches or in memory 830 (as opposed to storage 840 or elsewhere). One or more memory buses (which may each include an address bus and a data bus) may couple processor 820 to memory 830. Bus 870 may include one or more memory buses, as described in further detail below. In particular embodiments, one or more memory management units (MMUs) reside between processor 820 and memory 830 and facilitate accesses to memory 830 requested by processor 820. In particular embodiments, memory 830 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 830 may include one or more memories 830, where appropriate. Although this disclosure describes and illustrates particular memory, this disclosure contemplates any suitable memory.

In particular embodiments, storage 840 includes mass storage for data or instructions. As an example and not by way of limitation, storage 840 may include a hard disk drive (HDD), a floppy disk drive, flash memory, an optical disc, a magneto-optical disc, magnetic tape, or a Universal Serial Bus (USB) drive or a combination of two or more of these. Storage 840 may include removable or non-removable (or fixed) media, where appropriate. Storage 840 may be internal or external to computer system 810, where appropriate. In particular embodiments, storage 840 is non-volatile, solid-state memory. In particular embodiments, storage 840 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 840 taking any suitable physical form. Storage 840 may include one or more storage control units facilitating communication between processor 820 and storage 840, where appropriate. Where appropriate, storage 840 may include one or more storages 840. Although this disclosure describes and illustrates particular storage, this disclosure contemplates any suitable storage.

In particular embodiments, I/O interface 850 includes hardware, software, or both, providing one or more interfaces for communication between computer system 810 and one or more I/O devices. Computer system 810 may include one or more of these I/O devices, where appropriate. One or more of these I/O devices may enable communication between a person and computer system 810. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 850 for them. Where appropriate, I/O interface 850 may include one or more device or software drivers enabling processor 820 to drive one or more of these I/O devices. I/O interface 850 may include one or more I/O interfaces 850, where appropriate. Although this disclosure describes and illustrates a particular I/O interface, this disclosure contemplates any suitable I/O interface.

In particular embodiments, communication interface 860 includes hardware, software, or both providing one or more interfaces for communication (such as, for example, packet-based communication) between computer system 810 and one or more other computer systems 810 or one or more networks. As an example and not by way of limitation, communication interface 860 may include a network interface controller (NIC) or network adapter for communicating with an Ethernet or any other wire-based network or a wireless NIC (WNIC) or wireless adapter for communicating with a wireless network, such as a WI-FI network. This disclosure contemplates any suitable network and any suitable communication interface 860 for it. As an example and not by way of limitation, computer system 810 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 810 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or any other suitable wireless network or a combination of two or more of these. Computer system 810 may include any suitable communication interface 860 for any of these networks, where appropriate. Communication interface 860 may include one or more communication interfaces 860, where appropriate. Although this disclosure describes and illustrates a particular communication interface, this disclosure contemplates any suitable communication interface.

In particular embodiments, bus 870 includes hardware, software, or both coupling components of computer system 810 to each other. As an example and not by way of limitation, bus 870 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 870 may include one or more buses 870, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A sensory system of a vehicle, comprising:
a sensor unit comprising one or more sensors;
a solar-energy collecting panel configured to shield the sensor unit from solar radiation and generate energy from solar radiation;
an electrical energy storage device configured to store the energy generated by the solar-energy collecting panel; and
a cooling system powered by at least the electrical energy storage device and configured to cool the sensor unit.

2. The system of claim 1, wherein the electrical energy storage device powers the cooling system when the vehicle is stationary.

3. The system of claim 1, wherein the cooling system is configured to cool the sensor unit when the vehicle is stationary.

4. The system of claim 1, wherein a first turbine is positioned in a space between the sensor unit and the solar-energy collecting panel and coupled to the storage device, and the first turbine is configured to be impelled by horizontally-oriented airflow entering the space between the sensor unit and the solar-energy collecting panel, and further configured to provide electrical power to the storage device.

5. The system of claim 4, wherein the space between the sensor unit and the solar-energy collecting panel is open to allow exterior horizontally-oriented air flow into the space.

6. The system of claim 5, further comprising a second turbine configured to be impelled by vertical airflow entering the space between the sensor unit and the solar-energy collecting panel from the sensor unit, and coupled to the storage device.

7. The system of claim 1, wherein the cooling system comprises a fan, a thermoelectric cooler, or a pump.

8. The system of claim 1, further comprising a piezoelectric transducer coupled to the solar-energy collecting panel and the storage device, wherein the piezoelectric transducer is configured to generate electrical energy for storage by the storage device.

9. The system of claim 1, further comprising a thermoelectric generator coupled to the solar-energy collecting panel and the storage device, wherein the thermoelectric generator is configured to generate electrical energy for storage by the storage device.

10. The system of claim 1, further comprising:
a temperature-controlled case for the sensor unit.

11. The system of claim 1, further comprising a controller unit coupled to the cooling system, storage device, and solar-energy collecting panel and configured to actuate and route power to the cooling unit based on one or more sensor inputs.

12. The system of claim 11, wherein the controller unit is further configured to:
determine a temperature of the sensor system based on data from a temperature sensor connected to the controller unit; and
actuate and route power to the cooling system in response to determining that the temperature of the sensor system exceeds an operating temperature range of the sensor system.

13. The system of claim 12, wherein the controller is further configured to:
route power to the cooling system from the electrical energy storage device to the cooling system when an amount of energy stored in the electrical energy storage device is greater than zero.

14. The system of claim 11, wherein the controller unit is further configured to:
determine that the electrical energy storage device is accumulating electrical energy at a higher rate than the cooling system is consuming electrical energy; and
route power from the electrical energy storage device to one or more subsystems of the vehicle.

15. The system of claim 11, wherein the controller unit is further configured to:
determine that the cooling system is consuming electrical energy at a higher rate than the electrical energy storage device is accumulating electrical energy; and
route power from the vehicle's power supply to the cooling system while the cooling system is consuming electrical energy at a higher rate than the electrical energy storage device is accumulating electrical energy.

16. The system of claim 15, wherein the controller unit is further configured to:
determine, based on a rate at which the cooling system is consuming electrical energy and an amount of energy stored in the electrical energy storage device, an amount of time remaining before depletion of the energy stored in the electrical energy storage device; and
routing power from the vehicle's power supply to the cooling system when the determined amount of time has elapsed.
